(19) United States
(12) Patent Application Publication
(10) Pub. No.: US 2023/0118613 A1
(43) Pub. Date: Apr. 20, 2023

(54) SYSTEM, METHOD AND APPARATUS OF ANALYTICAL CRITERIA FOR COMPOSITE STRUCTURE DURABILITY AND CERTIFICATION

(71) Applicant: The Boeing Company, Chicago, IL (US)

(72) Inventors: Joseph D. Schaefer, St. Louis, MO (US); Brian P. Justusson, St. Louis, MO (US)

(73) Assignee: The Boeing Company, Chicago, IL (US)

(21) Appl. No.: 17/501,798

(22) Filed: Oct. 14, 2021

(51) Int. Cl. G06F 30/20

(52) U.S. Cl. CPC G06F 30/20

(57) ABSTRACT

Systems, apparatuses and methods provides for technology that generates a plurality of discrete and finite elements associated with a component, where a number of the plurality of discrete and finite elements corresponds to a size of an estimated process zone. The technology further identifies material input properties of the component, models crack propagation throughout the plurality of discrete and finite elements based on the material input properties and models a release response in the plurality of discrete and finite elements based on the material input properties.

### FIELD

Examples generally relate to stress and fracture-based damage initiation and growth modelling. More particularly, examples relate to a unified approach to model no-growth and slow-growth crack formation in various materials to analyze crack and/or fracture propagation under various individual or combined loading conditions (e.g. static, fatigue, impact, etc.) to schedule maintenance, design components and meet regulatory certification requirements while reducing a number of tests.

### BACKGROUND

Designing and certifying a structure for an aircraft can be an arduous process typically requiring physical testing to demonstrate the durability and damage tolerance of the structure. The durability and damage tolerance criteria and structural requirements are set by program engineers, and often differ across structural applications within industry (e.g. commercial aviation, military, space). Under certain circumstances, testing can be reduced through the use of structural modeling; however, failure of structures, particularly composite structures, are difficult to accurately model. Thus, some airframe developers adhere to a “no-growth” design criteria (no damage is allowed to grow in the structure) in which conservative designs are employed to ensure that should damage appear in the structure, the damage does not grow under normal operating conditions (e.g. static and fatigue loads in the form of a loads spectrum due to flight conditions). These designs are validated prior to deployment and undergo multiple layers of physical static and fatigue testing within the design-test-certification building block (e.g. comprehensive test program).

The static and fatigue testing required to achieve certification to no-growth criteria results in significant costs (e.g., hundreds of millions of United States dollars) and latency (e.g., a period of years). For example, the physical static testing includes loading structure at a quasi-static load or displacement rate to identify the onset of critical structural failure modes and track their growth until an ultimate failure condition occurs to determine an ultimate strength value as defined by the engineers. Fatigue testing can include replicate testing to determine a strength to stress and/or force verse life relationship under cyclic loading (e.g., generate a stress-life diagram (S-N)), and requires a lengthy period of time and at multiple load/stress-ratio levels (e.g. tension-tension, tension-compression, and compression-compression load ratios (min/max load) consisting of multiple load conditions (percent of target static load determined from static testing). Both static and fatigue testing is performed at multiple levels of the design-test-certification building block for the structure (e.g., coupon, sub-element, elements, sub-components and components) additionally increasing complications, latency, cost and time. Moreover, many conventional alternatives to physical testing can be inapplicable for modelling small cracks which affect structural durability, and are not applicable to fatigue testing (no-growth/slow growth).

### SUMMARY

In accordance with one or more examples, at least one non-transitory computer readable storage medium comprises a set of instructions, which when executed by a computing device, causes the computing device to generate a plurality of discrete and finite elements associated with a component, where a number of the plurality of discrete and finite elements corresponds to a size of an estimated process zone. The one or more examples further identify material input properties of the component, model a release response in the plurality of discrete and finite elements based on the material input properties, and model crack initiation and propagation throughout the plurality of discrete and finite elements based on the release response.

In accordance with one or more examples, provided is a computing device comprising at least one processor, and at least one memory coupled to the at least one processor. The at least one memory includes a set of instructions, which when executed by the at least one processor, causes the computing device to generate a plurality of discrete and finite elements associated with a component, where a number of the plurality of discrete and finite elements corresponds to a size of an estimated process zone. The set of instructions, which when executed by the at least one processor, causes the computing device to identify material input properties of the component, model a release response in the plurality of discrete and finite elements based on the material input properties, model crack initiation and propagation throughout the plurality of discrete and finite elements based on the release response.

In accordance with one or more examples, provided is a method including generating a plurality of discrete and finite elements associated with a component, where a number of the plurality of discrete and finite elements corresponds to a size of an estimated process zone. The method further includes identifying material input properties of the component, modelling a release response in the plurality of discrete and finite elements based on the material input properties and modelling crack propagation throughout the plurality of discrete and finite elements based on the release response.

The features, functions, and advantages that have been discussed can be achieved independently in various embodiments or can be combined in yet other embodiments further details of which can be seen with reference to the following description and drawings.

### BRIEF DESCRIPTION OF THE DRAWINGS

The various advantages of the examples will become apparent to one skilled in the art by reading the following specification and appended claims, and by referencing the following drawings, in which:

FIG. 1 is an illustration of an example of a modelling process to model crack propagation and crack propagation growth rate;

FIG. 2 is an illustration of an overhead view of a component;

FIG. 3 is an illustration of a comparative example and a current example;

FIG. 4 is an illustration of a method implementing one or more aspects of the modelling process;

FIG. 5 is an illustration of a computational progressive damage and failure analysis graphs;

FIG. 6 is an illustration of using advanced analysis and enhanced criteria; and

FIG. 7 is an illustration of a method of crack modelling.

### DESCRIPTION

Some examples relate to enhanced design applications where a ‘slow-growth’ criteria may be implemented to ensure that any damage that occurs due to service history will not grow rapidly to a critical structural condition prior to observation or inspection. Other approaches adopt testing for structural slow growth that is tremendously expensive, as it requires time-consuming testing similar to the no-growth static and fatigue testing, but also includes advanced local non-destructive inspection equipment (e.g. ultrasonics, digital image correlation, in-situ radiography, acoustic emission, structural health monitoring) to identify damage onset and growth behavior (e.g. morphology/size/shape/damage mode). As such, in other implementations a ‘slow-growth’ design criteria is not typically pursued due to the sheer expense and uncertainty associated with testing.

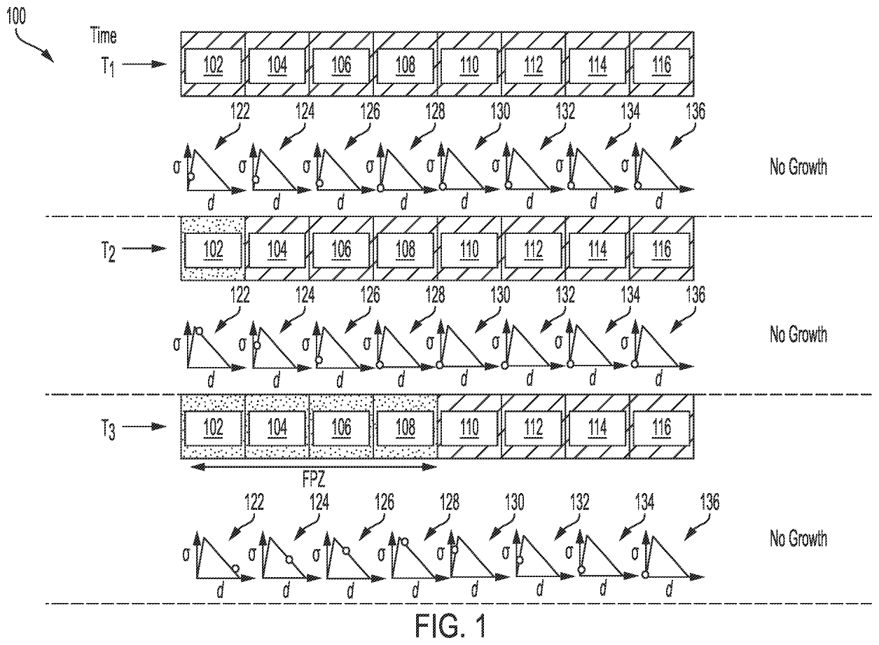

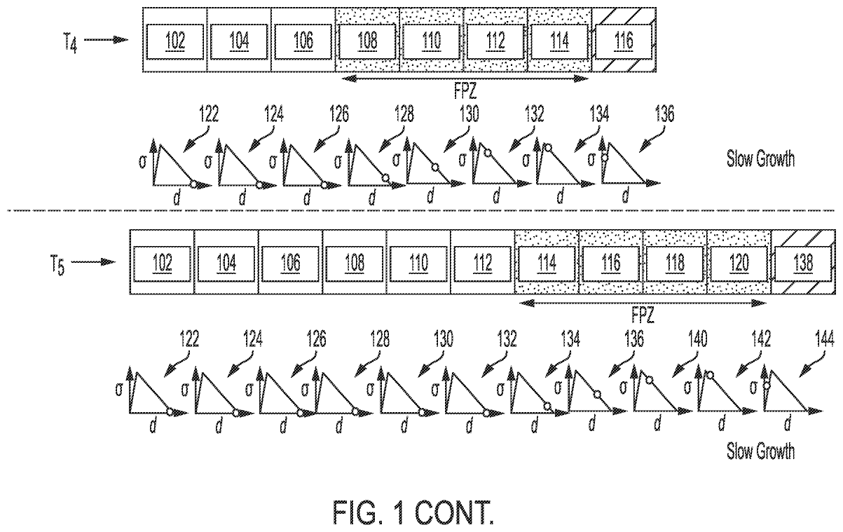

Turning now to FIG. 1, a modelling process 100 is illustrated. The modelling process 100 can predict a strength of a system (e.g., aircraft, vehicle, etc.) that includes a developing crack based on a process zone (which may be referred to as a material process zone) analysis. The modelling process 100 describes no-growth criteria and slow growth criteria across various loading conditions (e.g., static, fatigue, etc.) to predict the onset of damage and growth of damage to evaluate the potential impact of a small and long cracks in order to disposition the system for repair or further to effectively estimate a life of the system. The modelling process 100 includes a first analytical capability to predict when damage “starts” to grow (e.g., an onset criteria for “no-growth”). The modelling process 100 includes a second analytical capability to predict the trajectory and rate of damage growth (e.g., propagation criteria for “slow-growth”). The modelling process 100 includes an ability to perform the above for different composite failure modes including matrix, fiber, and interface (e.g., disbond). The modelling process 100 can perform the above for static, impact and fatigue (e.g., durability and/or damage tolerance) loading conditions and/or criteria.

The modelling process 100 therefore provides a common denominator (e.g., the material process zone) for onset/no-growth/slow-growth. Once the process zone is effectively set based on the material properties and objective meshing strategy, a remainder of the modelling process 100 can be an application (e.g. load type). The modelling process 100 uses an objectively set process zone to serve applications such as no-growth, slow-growth, etc. for static and fatigue loading. The process zone establishes an energy-basis criteria which unifies all down-stream applications to the same underlying mathematics and/or mechanics.

Some examples are applicable to system design and prior to deployment. In such examples, the modelling process 100 can provide an indication of whether modifications to the system design is desirable to modify elements (e.g., structure, materials, etc.) of the system to mitigate potential crack development and growth during deployment. For example, the modelling process 100 can execute over different types of material component designs in an efficient manner to identify designs that are the most durable (e.g., the onset of cracking) or damage tolerant (e.g., initiates testing from a known flaw condition) and eliminate designs that are substandard. Conventional implementations lack the ability to employ computer implemented architectures to predict small crack growth and effectively model small cracks, and instead rely on expensive and long-latency physical testing. For example, standard approaches for durability and damage tolerance require a flaw size to be minute (e.g., 0.010). Conventional implementations cannot account for such minute flaw sizes. As noted above, examples herein identify, define, and describe a process by which a common approach based on process zone establishment and propagation may be utilized to enhance decisions based on any design philosophy.

In some examples, the modelling process 100 provides an enhanced process to estimate durability and/or damage tolerance and can guide decision making processes such as what materials, layups and/or geometries to use in the system (e.g., to generate a fully defined system), a repair time of the system and whether the system needs repair. Thus, if damage is identified in the system, the modelling process 100 can effectively model and predict a growth of the crack to determine when repair will be needed, whether the system is able to be utilized and whether a life of the system can be extended. Furthermore, the modelling process 100 can address certification related analysis to permit aircrafts to operate and identify types of materials and structures to utilize in aircrafts. The above modelling process 100 can be applicable to any material system wherein crack growth conditions exist (thermosets, thermoplastics, ceramic matrix composites, metal matrix composites, cementitious materials, metals and alloys, etc.).

The modelling process 100 is implemented with a computing device, architecture and/or system. For example, the modelling process 100 can be implemented at least partly in one or more modules as a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

As illustrated, the modelling process 100 generates a finite framework that includes a plurality of discrete and finite elements 102, 104, 106, 108, 110, 112, 114, 116 associated with a component (e.g., aircraft), where a number of the plurality of discrete and finite elements 102, 104, 106, 108, 110, 112, 114, 116 corresponds to a size of an estimated process zone (e.g., to include at least three discrete and finite elements within the process zone). The process zone is an area that is beginning to have an increasing opening displacement and decreasing strength (e.g., will begin to develop a crack), and represents a region that is beginning to fail ahead of the traction free crack tip. For example, a size of the process zone can be predicted based on material properties, and the plurality of discrete and finite elements 102, 104, 106, 108, 110, 112, 114, 116 can be sized to be at most, one-third of the size of the process zone or less assuming at least 3 elements are within the process zone. The process zone can be a plurality of elements (such as the plurality of discrete and finite elements 102, 104, 106, 108, 110, 112, 114, 116) that are experiencing a reduction in element stiffness for each subsequent incremental increase in displacement for the mode of interest. The finite framework can be defined by a distance geometrically determined using common material properties for strength and stiffness of the associated material principal modes (e.g., mode I that is an opening mode, mode II that is a sliding mode, mode III that is a tearing mode) in 3 dimensions. In some examples, a process zone length can be set by composite engineering constants and/or input properties. The condition for an intralaminar fracture process zone length can be provided by well-known models.

The modelling process 100 includes identifying material input properties (e.g. modulus, strength, fracture toughness) of the component and modelling crack propagation throughout the plurality of discrete and finite elements 102, 104, 106, 108, 110, 112, 114, 116 based on the material input properties. The modelling process 100 further models a release response in the plurality of discrete and finite elements 102, 104, 106, 108, 110, 112, 114, 116 based on the material input properties as illustrated in release responses (graphs) 122, 124, 126, 128, 130, 132, 134, 136.

In some examples, the modelling process 100 can model crack propagation (e.g., a rate of crack growth) and development at the initial stages of development where linear-elastic fracture mechanics (LEFM) is inapplicable, to a larger sized crack where LEFM is applicable. Below each of the plurality of discrete and finite elements 102, 104, 106, 108, 110, 112, 114, 116 is a corresponding release response 122, 124, 126, 128, 130, 132, 134, 136 (e.g., a traction-separation relationship based on traction-separation laws) that maps the relationship of strength σ to opening displacement d (corresponding to an applied load, force, pressure, displacement, etc.) of the plurality of discrete and finite elements 102, 104, 106, 108, 110, 112, 114, 116. That is, the modelling process 100 generates for each respective finite element of the plurality of discrete and finite elements 102, 104, 106, 108, 110, 112, 114, 116, a stress relationship between an opening displacement d of the respective finite element and strength σ of the respective finite element.

It is worthwhile to note that the shape of release response 122, 124, 126, 128, 130, 132, 134, 136 are based on the traction-separation law but do not have to be triangular as shown (e.g. bilinear). A variety of release shapes exist (e.g. trilinear, exponential, logarithmic, parabolic, custom) and can similarly be utilized. The approach described herein is framed such that regardless of the traction-separation law shape, all include a plurality of elements with a minimum number of the plurality of discrete and finite elements 102, 104, 106, 108, 110, 112, 114, 116, within the process zone for mesh objectively to be set; thus, the proposed unified criteria are applicable to those as well.

The opening displacement d corresponds to an opening size of the crack within the plurality of discrete and finite elements 102, 104, 106, 108, 110, 112, 114, 116. In this example, the release response 122 corresponds to the discrete and finite element 102. The release response 124 corresponds to the discrete and finite element 104. The release response 126 corresponds to the discrete and finite element 106. The release response 128 corresponds to the discrete and finite element 108. The release response 130 corresponds to the discrete and finite element 110. The release response 132 corresponds to the discrete and finite element 112. The release response 134 corresponds to the discrete and finite element 114. The release response 136 corresponds to the discrete and finite element 116.

As illustrated, the time can change throughout the modelling process 100. The time can correspond to cycles or iterations (e.g., as time increases the number of cycles and iterations increases). While time is illustrated, other measurements can readily be utilized, such as increments within a solver. Increments can differ from one another based in time space, load-space, displace-space, cycle-space, etc. throughout the modelling process 100.

In this example, at a time T₁, the component is unloaded and the material forming the component includes an unillustrated crack adjacent to the plurality of discrete and finite elements 102, 104, 106, 108, 110, 112, 114, 116. The release responses 122, 124, 126 indicate that an opening displacement d is beginning to form in the discrete and finite elements 102, 104, 106. The plurality of discrete and finite elements 102, 104, 106, 108, 110, 112, 114, 116 can be considered to be an in undamaged state since the plurality of discrete and finite elements 102, 104, 106, 108, 110, 112, 114, 116 have enough strength to be considered stable. At time T₂, the first element, which is the discrete and finite elements 102, at the crack tip enters a release state. A release state indicates that the opening displacement d is increasing and the strength σ as well as stiffness has reached a maximum point, and is now decreasing (beginning to form a crack). The discrete and finite elements 104, 106, 108, 110, 112, 114, 116 are in the undamaged state.

At a time T₃, the modelling process 100 determines that a number of the discrete and finite elements 102, 104, 106, 108, 110, 112, 114, 116 have entered release and therefore form a process zone FPZ. That is, when the number meets a formation threshold (e.g., 3-5), the modelling process 100 determines that the process zone FPZ is fully formed and that a crack is beginning to form. Notably, the crack is not yet formed through the process zone FPZ, but the modelling process 100 predictively determines that the crack is beginning to form through the process zone FPZ. The process zone FPZ size can remain constant throughout the modelling process 100, but change position to be at the crack tip. The process zone FPZ indicates an area at the crack tip that will fail (e.g., is damaged but is not yet fully a crack) to enlarge the crack.

In this example, the discrete and finite elements 102, 104, 106, 108 at the crack tip have entered a release state. Since the number of discrete and finite elements 102, 104, 106, 108 meets the formation threshold, the process zone FPZ is fully formed through the discrete and finite elements 102, 104, 106, 108. The release responses 122, 124, 126, 128 now have increasing opening displacements d and diminishing strength σ as well as modulus/stiffness. Both reduce to a nominally small value, typically non-zero. In some examples, the degradation ratio is 0.99 or higher (where the resulting remaining strength/stiffness is 0.01 or less). However, the actual values can be tailored to achieve various modeling behaviors as desired.

Thus, at the time T₃, the process zone FPZ (which can be referred to as a numeric process zone) includes the discrete and finite elements 102, 104, 106, 108 and is fully formed. The discrete and finite elements 110, 112, 114, 116 are in the undamaged state. The process zone FPZ is numeric failure process zone and is an area between an open crack state and a non-affected (undamaged) state. The process zone FPZ is positioned between an open crack portion and a non-affected and/or undamaged portion and represents an area that will fail and enlarge the crack absent intervention, thus entering a crack propagation state.

In some examples, the modelling process 100 includes identifying at least three discrete and finite elements of the discrete and finite elements 102, 104, 106, 108, 110, 112, 114, 116 as being in a release state based on the release responses 122, 124, 126, 128. Based on as much, the modelling process 100 determines that the at least three discrete and finite elements form the process zone FPZ.

At time T₄ the fully formed process zone FPZ has started to progress (move), and the no-growth criteria limit is reached (crack has spread) thus placing the component into a damaged growth state. That is, the crack has developed at the discrete and finite elements 102, 104, 106. Thus, the discrete and finite elements 102, 104, 106 are in a crack state. Some examples include utilization of traction separation laws to identify the crack. As such, the modelling process 100 identifies that the discrete and finite elements 102, 104, 106 of the discrete and finite elements 102, 104, 106, 108, 110, 112, 114, 116 as being in an open crack state based on the release responses 122, 124, 126. The modelling process 100 can also predict crack propagation growth rate (how quickly the crack increases in size) and crack propagation (a size of the crack at a specific time) as well as crack direction and/or trajectory based on the above. For example, the crack propagation growth rate can be identified based on how quickly the crack grows during different time intervals (e.g., from T₄ to T₃ for static, fatigue, etc.). The modelling process 100 identifies the discrete and finite element 116 as being in an unreleased state based on the release responses 136, while the discrete and finite elements 108, 110, 112, 114 are in a release state.

The modelling process 100 identifies that the release responses 122, 124, 126 indicate that the strength σ has reached zero and the displacement d is at a maximum. Based on as much, the modelling process 100 determines that the discrete and finite elements 102, 104, 106 are in the open cracked state. Further, the modelling process 100 progresses to predict the crack growth trajectory and progress from which an analyst/engineer can determine/predict the crack growth rate (e.g. slow-growth analysis, fast growth/fast fracture analysis).

At time T₅, the fully formed process zone FPZ has progressed, and the crack growth can be evaluated for the application of different growth criteria based on rate, trajectory, extent, etc. In this example, the discrete and finite elements 102, 104, 106, 108, 110, 112 are in a crack state, the discrete and finite elements 114, 116, 118, 120 are in a release state and discrete and finite elements 138 is in an undamaged state. As illustrated, the modelling process 100 can adjust to include more discrete and finite elements 118, 120, 138 as well as corresponding release responses 140, 142, 144 at time T₅ to model future crack progression.

Based on the progression of the crack, a crack growth rate can be identified. For example, the crack growth rate can be a size of crack growth with respect to an interval of time between times T₄ and T₅. If the crack growth rate exceeds a certain amount (e.g., meets a threshold), remedial actions can be undertaken such as inspection, repair or maintenance. In some examples, the crack growth rate can be used to predict a size of the crack in the future, and a time (or cycle) at which the crack will have reached a size that requires remedial measures. The crack length at various times can therefore be predicted based on the crack growth rate.

Thus, the modelling process 100 identifies whether each respective finite element of the plurality of discrete and finite elements 102, 104, 106, 108, 110, 112, 114, 116, 118, 120, 138 is in a crack state, a release state, or an undamaged state based on the stress relationship of the respective finite element as shown in the release response 122, 124, 126, 128, 130, 132, 134, 136, 140, 142, 144. In some examples, the modelling process 100 can further determine a crack propagation growth rate based on the stress relationships of the release response 122, 124, 126, 128, 130, 132, 134, 136, 140, 142 and an identification of whether the discrete and finite elements 102, 104, 106, 108, 110, 112, 114, 116, 118, 120, 138 are in the crack state, the release state or the undamaged state. In such examples, the modelling process 100 further projects a crack progression (e.g., determines a future size of the crack) based on the crack propagation growth rate and the crack propagation through the discrete and finite elements 102, 104, 106, 108, 110, 112, 114, 116, 118, 120, 138.

In some examples, the modelling process 100 further models the crack propagation, the crack propagation growth rate and the release response across a plurality of failure modes (e.g., fracture failure mode, static failure mode, fatigue failure mode, etc.) and identifies one or more physical modifications to the component to increase a safety factor (e.g., mitigate a potentially dangerous outcome) associated with the component based on the stress relationships for example by modifying the component (e.g., determine different materials to include in the component). In some examples, the modelling process 100 models the crack propagation, the crack propagation growth rate and the release response across a plurality of loading modes, where the plurality of loading modes includes one or more of a static load, an impact load or a fatigue load. For example, the modelling process 100 can be modified to operate under different loading constraints. As noted above, the materials may be of various types, and are part of a system wherein crack growth conditions exist (e.g., materials can include thermosets, thermoplastics, ceramic matrix composites, metal matrix composites, cementitious materials, metals and alloys, etc.).

In some examples, the modelling process 100 can predict when the component will have a crack that requires inspection and repair. In such examples, the modelling process 100 can schedule maintenance to occur in the future and/or inform a user of as much. That is, the modelling process 100 can execute prior to a component being used to determine an approximate time frame at which a crack and/or process zone FPZ will be forming to schedule maintenance. Notably, the process zone FPZ is beneath an inspection scale and is not easily detectable. Examples herein can identify the process zone FPZ and adopt actions accordingly. It is further worthwhile to note that the process zone FPZ does not have a crack fully formed. Thus, the modelling process 100 can identify elements that have diminishing strength σ and diminishing stiffness that will develop cracks. Notably, conventional applications are unable to adequately model such a release response of the process zone FPZ and instead generate a singularity to represent the process zone FPZ. Examples as described herein overcome such conventional drawbacks by effectively modelling the process zone FPZ as described above to model failure over time.

In some examples, the modelling process 100 identifies that at least three discrete and finite elements of the discrete and finite elements 102, 104, 106, 108, 110, 112, 114, 116, 118, 120, 138 have entered the release process to determine that the process zone FPZ is formed. The process zone FPZ is estimated from material properties (e.g. stiffness), and a user and/or computer sets a finite element mesh size to allow for at least three discrete and finite elements to geometrically exist within a predicted minimum size of the process zone FPZ.

For example, if the opening mode (Mode I) fracture process zone is 0.6 mm, then the element size would be a maximum of 0.2 mm to allow for three discrete and finite elements to fit within the opening mode process zone (which can be similar to the process zone FPZ). Within the computational approach, this generally provides thermodynamically consistent energy release and creates a mesh objective to the analysis based on the internal damage variables of an analysis software. More than three discrete and finite elements can be used to model a process zone, but not less in some examples to utilize both stress and fracture mechanics, which enables the process zone FPZ to develop objectively within the finite element model. The modelling process 100 uses the above capabilities as an enhanced criteria for structural analysis, modification and design.

Examples as described herein implement the above based on the following Equations 1-5:

$$\text{?} \qquad Equation 1$$

$$\text{?} \qquad Equation 2$$

$$\text{?} \qquad Equation 3$$

$$\text{?} \qquad Equation 4$$

$$\text{?} \qquad Equation 5$$

$$\text{?} \text{indicates text missing or illegible when filed}$$

Q is a function of orthotropic stiffness, G is fracture toughness with the notation indicating the material principle directions, E is material modulus and t is traction/stress. T is traction/stress/strength (in this example, shear strength); γ is a crack tip shape parameter (e.g., also known as an m value which is a coefficient that affects the ‘intensity’ of the crack tip and can range from ˜0.15 to 1). The variable γ is set by the user based on desired practices (e.g., 1 to maintain simplicity). Q is the stiffness matrix for the composite material (at least for this example) based on E stiffness, v Poisson ratio, and G shear stiffness.

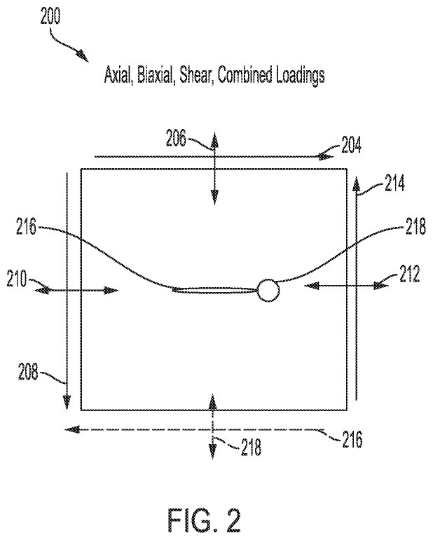

FIG. 2 illustrates a component 200 (e.g., a general continuum model with central crack/defect/damage condition). The modelling process 100 can model the propagation of crack 216 (e.g., an existing crack). The component 200 is subject to several different types of loading, including axial, biaxial shear and combined loadings 204, 206, 208, 210, 212, 214. The modelling process 100 can recommend modifications based on the crack 216, such as more frequent maintenance and inspection intervals. As noted above, in some examples the modelling process 100 can predict when cracks will begin to develop and recommend actions based on when the cracks will develop (e.g., inspection and/or change material designs). For example, the modelling process 100 can execute at area 218 which is at a tip of the crack 216.

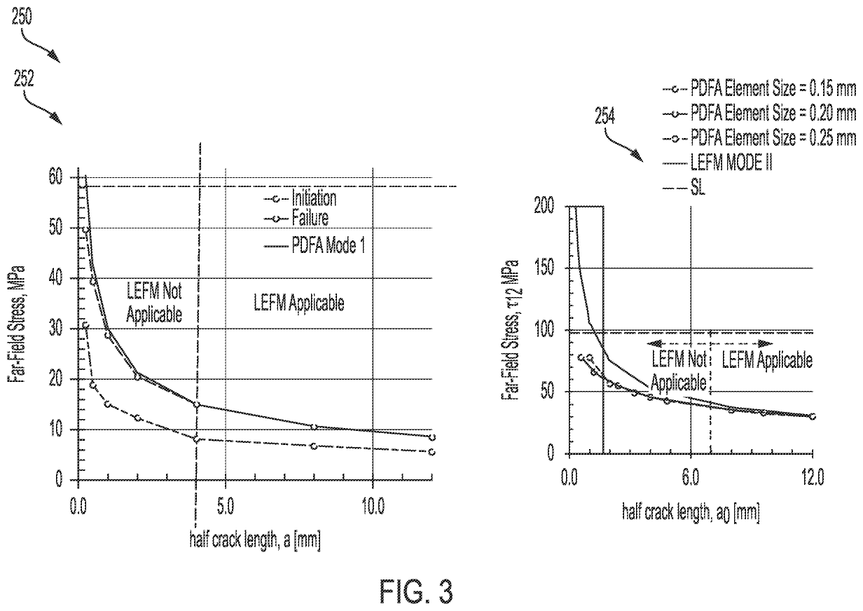

FIG. 3 illustrates a comparative example 250. In comparative example 250, examples execute based on traction-separation laws that are applicable to the short-crack domain, where linear elastic fracture mechanics (LEFM) do not apply, and bridge the gap between LEFM and strength dominant responses in Mode I and Mode II loading conditions. Graphs 252 and 254 illustrate that the modelling process 100 (e.g., a process zone based approach) is superior to LEFM for small crack growth. In both graphs 252, 254, the LEFM approaches a singularity when the crack is sufficiently small, thus becoming ineffective. In contrast, the initiation, failure and progressive damage and failure analysis (PDFA) lines illustrate the output of the modelling process 100 and notably do not result in a singularity for far-field stress. Thus embodiments effectively analyze additively manufactured metallic structure, where flaw sizes and manufacturing build anomalies/defects are smaller than the length scale where LEFM applies. The above approach can also effectively model many other material systems also noted previously.

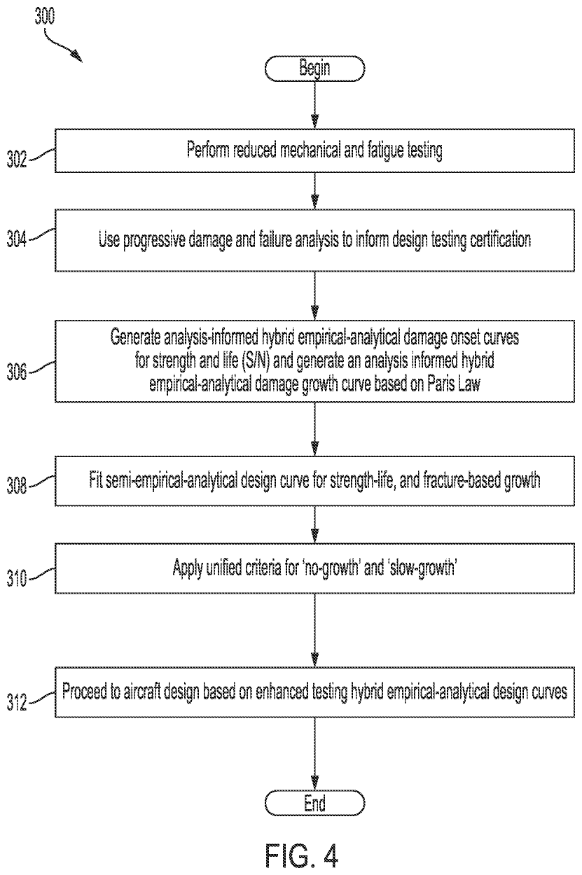

FIG. 4 shows a method 300 of execute the modelling process 100. The method 300 is generally implemented by any of the examples described herein. For example, the method 300 can be executed in conjunction with process 100 (FIG. 1).

In an example, the method 300 is implemented at least partly in one or more modules as a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

Illustrated processing block 302 performs reduced mechanical and fatigue testing on various components and various failure modes (e.g., fracture failure mode, static failure mode, fatigue failure mode, etc.) at different levels or length scales (e.g., coupon, sub-element, sub-component, component, etc.). Illustrated processing block 304 uses progressive damage and failure analysis as described above to inform design testing certification. Illustrated processing block 306 generates an analysis-informed hybrid empirical-analytical damage onset curves for strength and life (S/N) and generates an analysis informed hybrid empirical-analytical damage growth curve based on Paris Law. Illustrated processing block 308 fits semi-empirical-analytical design curve for strength-life, and fracture-based growth. Illustrated processing block 310 applies a unified criteria for “no-growth” and “slow-growth” as discussed above to model crack propagation and growth. Illustrated processing block 312 proceeds to aircraft design based on enhanced testing hybrid empirical-analytical design curves. Method 300 results in a reduced number of static and fatigue tests to create No-Growth (S/N based) and Slow-Growth (Paris-Law/Fracture based) design curves for new aircraft types. In some examples, the method 300 further includes automatically adjusting structural design of the aircraft types to meet metrics of crack propagation and growth rates, and increase a safety factor (e.g., mitigate potentially dangerous conditions). For example, structural design or features are modified to increase the margin where it is found that the design does not meet the design criteria. Thus, some examples include at least a minimum safety factor of some value, and seek to increase safety factors such that a suitable margin is achieved based on the program design requirements.

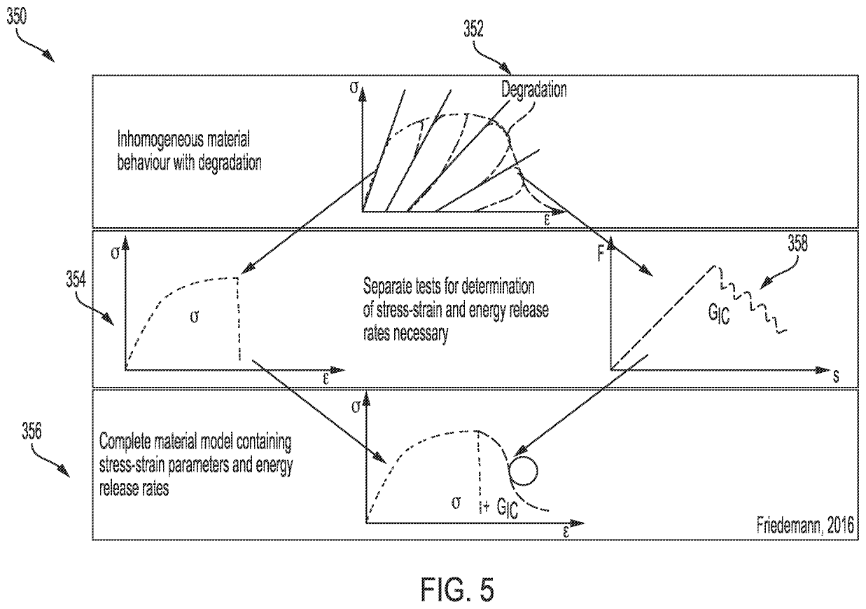

FIG. 5 illustrates computational progressive damage and failure analysis graphs 350 for modeling process zones which are subsequently used to analyze static/fatigue/impact/etc. loading condition. As illustrated, graph 352 shows a complex combination of matrix/fiber/delamination modes, and stress and fracture-based responses. Graph 354 illustrates strength mechanics. Graph 358 illustrates fracture mechanics. Graph 356 is a complete material model containing stress-strain parameters and energy release rates according to the examples described herein, and can be generated based on modelling process 100 (FIG. 1). The graph 356 uses both strength (e.g., initiation) and fracture mechanics (e.g., failure) within each element.

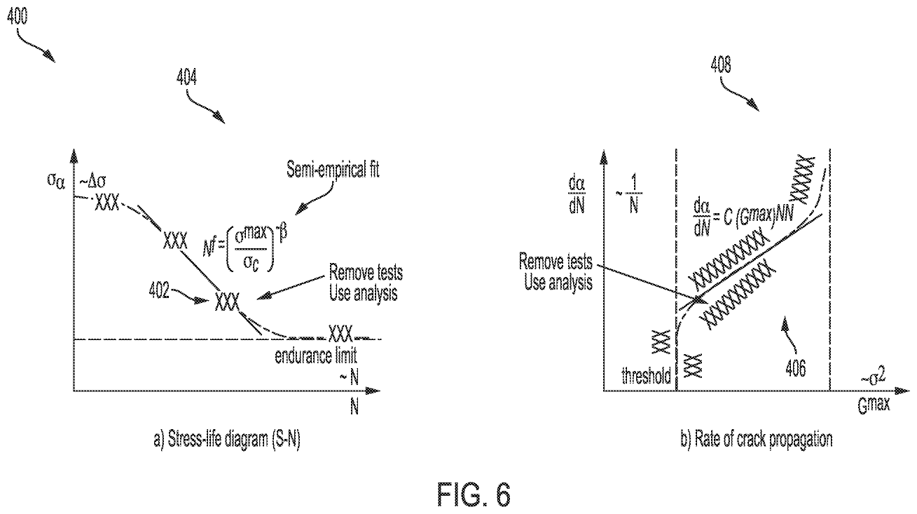

FIG. 6 illustrates an example of using advanced analysis and enhanced criteria for cohesive laws based on underlying physics and numeric implementation to perform efficient and enhanced testing. In detail, a stress-life graph 404 (e.g., no-growth analysis) includes a series of physical tests to generate a curve that represents a no-growth analysis (e.g., identifies when damage onset begins) over a series of cycles. In this example, the testing denoted by a series of “X” marks 402 is replaced with examples as described herein to remove the amount of physical testing that is executed, while also enhancing efficiency and predictively modeling strength-life. Similarly, the rate of crack propagation graph 408 (e.g., slow growth analysis) includes some physical testing to generate a curve that represents damage crack growth/extension as a function of cycle count/load history (e.g., crack propagation and growth) over a series of cycles. The physical testing denoted by a series of “X” marks 406 is replaced with examples as described herein to model crack propagation without physical testing. Doing so enhances efficiency since physical testing can be a long latency process, prone to error and expensive.

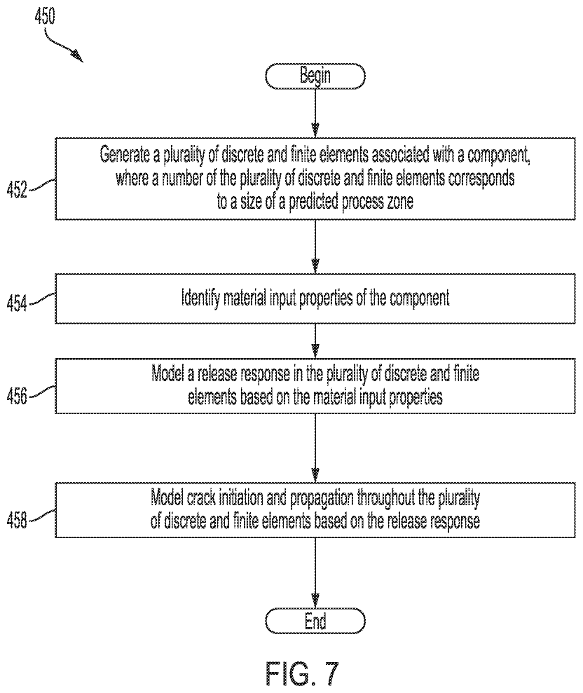

FIG. 7 shows a crack modelling method 450 that implements one or more aspects of the modelling process 100. The method 450 is generally implemented by any of the examples described herein. For example, the method 450 can be executed in conjunction with process 100 (FIG. 1).

In an example, the method 450 is implemented at least partly in one or more modules as a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

Illustrated processing block 452 generates a plurality of discrete and finite elements associated with a component, where a number of the plurality of discrete and finite elements corresponds to a size of an estimated process zone. Illustrated processing block 454 identifies material input properties of the component. Illustrated processing block 456 models a release response in the plurality of discrete and finite elements based on the material input properties. Illustrated processing block 458 models crack initiation and propagation throughout the plurality of discrete and finite elements based on the release response. In some examples, the method 400 includes identifying that at least three first finite elements of the plurality of discrete and finite elements as being in a release state based on the release response, and determining that the at least three first finite elements form a numeric process zone. In some examples, the method 400 includes identifying one or more second finite elements of the plurality of discrete and finite elements as being in a crack state based on the release response, and identifies one or more third finite elements of the plurality of discrete and finite elements as being in an unreleased state based on the release response.

In some examples, the method 400 generates for each respective discrete and finite element of the plurality of discrete and finite elements, a stress relationship between an opening displacement of the respective discrete and finite element and strength of the respective discrete and finite element. In some examples, the method 400 identifies whether each respective discrete and finite element of the plurality of discrete and finite elements is in an open crack state, a release state, or an undamaged state based on the stress relationship of the respective discrete and finite element, models a crack propagation growth rate based on the stress relationships and the discrete and finite elements being identified as being in the crack state, the release state and the undamaged state and projects (e.g., predicts) a crack progression based on the crack propagation growth rate and the crack propagation. In some examples, the method 400 includes modelling the crack propagation, the crack propagation growth rate and the release response across a plurality of failure modes and identifies one or more physical modifications to the component to increase a safety factor associated with the component based on the stress relationships. In some examples, the method 400 models the crack propagation, the crack propagation growth rate and the release response across a plurality of loading modes, wherein the plurality of loading modes includes one or more of a static load, an impact load or a fatigue load.

Further, the disclosure comprises additional examples as detailed in the following clauses below.

Claim 1. At least one non-transitory computer readable storage medium comprising a set of instructions, which when executed by a computing device, causes the computing device to:

generate a plurality of discrete and finite elements associated with a component, wherein a number of the plurality of discrete and finite elements corresponds to a size of an estimated process zone;

identify material input properties of the component;

model a release response in the plurality of discrete and finite elements based on the material input properties; and

model crack initiation and propagation throughout the plurality of discrete and finite elements based on the release response.

Clause 2. The at least one non-transitory computer readable storage medium of Clause 1, wherein the instructions, when executed, cause the computing device to:

identify that at least three first finite elements of the plurality of discrete and finite elements as being in a release state based on the release response; and

determine that the at least three first finite elements form a numeric process zone.

Clause 3. The at least one non-transitory computer readable storage medium of Clause 2, wherein the instructions, when executed, cause the computing device to:

identify one or more second finite elements of the plurality of discrete and finite elements as being in a crack state based on the release response; and

identify one or more third finite elements of the plurality of discrete and finite elements as being in an unreleased state based on the release response.

Clause 4. The at least one non-transitory computer readable storage medium of Clause 1, wherein the instructions, when executed, cause the computing device to:

generate for each respective discrete and finite element of the plurality of discrete and finite elements, a stress relationship between an opening displacement of the respective discrete and finite element and strength of the respective discrete and finite element.

Clause 5. The at least one non-transitory computer readable storage medium of Clause 4, wherein the instructions, when executed, cause the computing device to:

identify whether each respective discrete and finite element of the plurality of discrete and finite elements is in a crack state, a release state, or an undamaged state based on the stress relationship of the respective discrete and finite element;

model a crack propagation growth rate based on the stress relationships and the discrete and finite elements being identified as being in the crack state, the release state and the undamaged state; and

project a crack progression based on the crack propagation growth rate and the crack propagation.

Clause 6. The at least one non-transitory computer readable storage medium of Clause 5, wherein the instructions, when executed, cause the computing device to:

model the crack propagation, the crack propagation growth rate and the release response across a plurality of failure modes; and

identify one or more physical modifications to the component to increase a safety factor associated with the component based on the stress relationships.

Clause 7. The at least one non-transitory computer readable storage medium of Clause 6, wherein the instructions, when executed, cause the computing device to:

model the crack propagation, the crack propagation growth rate and the release response across a plurality of loading modes to bypass one or more testing processes associated with static and fatigue testing, wherein the plurality of loading modes includes one or more of a static load, an impact load or a fatigue load.

Clause 8. A computing device comprising:

at least one processor; and

at least one memory coupled to the at least one processor, the at least one memory including a set of instructions, which when executed by the at least one processor, causes the computing device to:

generate a plurality of discrete and finite elements associated with a component, wherein a number of the plurality of discrete and finite elements corresponds to a size of an estimated process zone;

identify material input properties of the component;

model a release response in the plurality of discrete and finite elements based on the material input properties; and

model crack initiation and propagation throughout the plurality of discrete and finite elements based on the release response.

Clause 9. The computing device of Clause 8, wherein the set of instructions, when executed by the at least one processor, cause the computing device to:

identify at least three first finite elements of the plurality of discrete and finite elements as being in a release state based on the release response; and

determine that the at least three first finite elements form a numeric process zone.

Clause 10. The computing device of Clause 9, wherein the set of instructions, when executed by the at least one processor, cause the computing device to:

identify one or more second finite elements of the plurality of discrete and finite elements as being in a crack state based on the release response; and

identify one or more third finite elements of the plurality of discrete and finite elements as being in an unreleased state based on the release response.

Clause 11. The computing device of Clause 8, wherein the set of instructions, when executed by the at least one processor, cause the computing device to:

generate for each respective discrete and finite element of the plurality of discrete and finite elements, a stress relationship between an opening displacement of the respective discrete and finite element and strength of the respective discrete and finite element.

Clause 12. The computing device of Clause 11, wherein the set of instructions, when executed by the at least one processor, cause the computing device to:

identify whether each respective discrete and finite element of the plurality of discrete and finite elements is in a crack state, a release state, or an undamaged state based on the stress relationship of the respective discrete and finite element;

model a crack propagation growth rate based on the stress relationships and the discrete and finite elements being identified as being in the crack state, the release state and the undamaged state; and

project a crack progression based on the crack propagation growth rate and the crack propagation.

Clause 13. The computing device of Clause 12, wherein the set of instructions, when executed by the at least one processor, cause the computing device to:

model the crack propagation, the crack propagation growth rate and the release response across a plurality of failure modes; and

identify one or more physical modifications to the component to increase a safety factor associated with the component based on the stress relationships.

Clause 14. The computing device of Clause 13, wherein the set of instructions, when executed by the at least one processor, cause the computing device to:

model the crack propagation, the crack propagation growth rate and the release response across a plurality of loading modes to bypass one or more testing processes associated with static and fatigue testing, wherein the plurality of loading modes includes one or more of a static load, an impact load or a fatigue load.

Clause 15. A method comprising

generating a plurality of discrete and finite elements associated with a component, wherein a number of the plurality of discrete and finite elements corresponds to a size of an estimated process zone;

identifying material input properties of the component;

modelling a release response in the plurality of discrete and finite elements based on the material input properties; and

modelling crack initiation and propagation throughout the plurality of discrete and finite elements based on the release response.

Clause 16. The method of Clause 15, further comprising:

identifying at least three first finite elements of the plurality of discrete and finite elements as being in a release state based on the release response; and

determine that the at least three first finite elements form a numeric process zone.

Clause 17. The method of Clause 16, further comprising:

identifying one or more second finite elements of the plurality of discrete and finite elements as being in a crack state based on the release response; and

identifying one or more third finite elements of the plurality of discrete and finite elements as being in an unreleased state based on the release response.

Clause 18. The method of Clause 15, further comprising:

generating for each respective discrete and finite element of the plurality of discrete and finite elements, a stress relationship between an opening displacement of the respective discrete and finite element and strength of the respective discrete and finite element.

Clause 19. The method of Clause 18, further comprising:

identifying whether each respective discrete and finite element of the plurality of discrete and finite elements is in a crack state, a release state, or an undamaged state based on the stress relationship of the respective discrete and finite element;

modelling a crack propagation growth rate based on the stress relationships and the discrete and finite elements being identified as being in the crack state, the release state and the undamaged state; and

projecting a crack progression based on the crack propagation growth rate and the crack propagation.

Clause 20. The method of Clause 19, further comprising:

modelling the crack propagation, the crack propagation growth rate and the release response across a plurality of failure modes to bypass one or more testing processes associated with static and fatigue testing; and

identifying one or more physical modifications to the component to increase a safety factor associated with the component based on the stress relationships.

Example sizes/models/values/ranges can have been given, although examples are not limited to the same. Arrangements can be shown in block diagram form in order to avoid obscuring examples, and also in view of the fact that specifics with respect to implementation of such block diagram arrangements are highly dependent upon the computing system within which the example is to be implemented, i.e., such specifics should be well within purview of one skilled in the art. The term “coupled” can be used herein to refer to any type of relationship, direct or indirect, between the components in question, and can apply to electrical, mechanical, fluid, optical, electromagnetic, electromechanical, or other connections. In addition, the terms “first”, “second”, etc. can be used herein only to facilitate discussion, and carry no particular temporal or chronological significance unless otherwise indicated.

As used in this application and in the claims, a list of items joined by the term “one or more of” can mean any combination of the listed terms. For example, the phrases “one or more of A, B or C” can mean A; B; C; A and B; A and C; B and C; or A, B and C.

Those skilled in the art will appreciate from the foregoing description that the broad techniques of the examples can be implemented in a variety of forms. Therefore, while the examples have been described in connection with particular examples thereof, the true scope of the examples should not be so limited since other modifications will become apparent to the skilled practitioner upon a study of the drawings, specification, and following claims.

We claim:

1. At least one non-transitory computer readable storage medium comprising a set of instructions, which when executed by a computing device, causes the computing device to:
generate a plurality of discrete and finite elements associated with a component, wherein a number of the plurality of discrete and finite elements corresponds to a size of an estimated process zone;
identify material input properties of the component;
model a release response in the plurality of discrete and finite elements based on the material input properties; and
model crack initiation and propagation throughout the plurality of discrete and finite elements based on the release response.

2. The at least one non-transitory computer readable storage medium of claim 1, wherein the instructions, when executed, cause the computing device to:
identify that at least three first finite elements of the plurality of discrete and finite elements as being in a release state based on the release response; and
determine that the at least three first finite elements form a numeric process zone.

3. The at least one non-transitory computer readable storage medium of claim 2, wherein the instructions, when executed, cause the computing device to:
identify one or more second finite elements of the plurality of discrete and finite elements as being in a crack state based on the release response; and
identify one or more third finite elements of the plurality of discrete and finite elements as being in an unreleased state based on the release response.

4. The at least one non-transitory computer readable storage medium of claim 1, wherein the instructions, when executed, cause the computing device to:
generate for each respective discrete and finite element of the plurality of discrete and finite elements, a stress relationship between an opening displacement of the respective discrete and finite element and strength of the respective discrete and finite element.

5. The at least one non-transitory computer readable storage medium of claim 4, wherein the instructions, when executed, cause the computing device to:
identify whether each respective discrete and finite element of the plurality of discrete and finite elements is in a crack state, a release state, or an undamaged state based on the stress relationship of the respective discrete and finite element;
model a crack propagation growth rate based on the stress relationships and the discrete and finite elements being identified as being in the crack state, the release state and the undamaged state; and
project a crack progression based on the crack propagation growth rate and the crack propagation.

6. The at least one non-transitory computer readable storage medium of claim 5,
wherein the instructions, when executed, cause the computing device to:
model the crack propagation, the crack propagation growth rate and the release response across a plurality of failure modes; and
identify one or more physical modifications to the component to increase a safety factor associated with the component based on the stress relationships.

7. The at least one non-transitory computer readable storage medium of claim 6, wherein the instructions, when executed, cause the computing device to:
model the crack propagation, the crack propagation growth rate and the release response across a plurality of loading modes to bypass one or more testing processes associated with static and fatigue testing, wherein the plurality of loading modes includes one or more of a static load, an impact load or a fatigue load.

8. A computing device comprising:
at least one processor; and
at least one memory coupled to the at least one processor, the at least one memory including a set of instructions, which when executed by the at least one processor, causes the computing device to:
generate a plurality of discrete and finite elements associated with a component, wherein a number of the plurality of discrete and finite elements corresponds to a size of an estimated process zone;
identify material input properties of the component;
model a release response in the plurality of discrete and finite elements based on the material input properties; and
model crack initiation and propagation throughout the plurality of discrete and finite elements based on the release response.

9. The computing device of claim 8, wherein the set of instructions, when executed by the at least one processor, cause the computing device to:
identify at least three first finite elements of the plurality of discrete and finite elements as being in a release state based on the release response; and
determine that the at least three first finite elements form a numeric process zone.

10. The computing device of claim 9, wherein the set of instructions, when executed by the at least one processor, cause the computing device to:
identify one or more second finite elements of the plurality of discrete and finite elements as being in a crack state based on the release response; and
identify one or more third finite elements of the plurality of discrete and finite elements as being in an unreleased state based on the release response.

11. The computing device of claim 8, wherein the set of instructions, when executed by the at least one processor, cause the computing device to:
generate for each respective discrete and finite element of the plurality of discrete and finite elements, a stress relationship between an opening displacement of the respective discrete and finite element and strength of the respective discrete and finite element.

12. The computing device of claim 11, wherein the set of instructions, when executed by the at least one processor, cause the computing device to:
identify whether each respective discrete and finite element of the plurality of discrete and finite elements is in a crack state, a release state, or an undamaged state based on the stress relationship of the respective discrete and finite element;
model a crack propagation growth rate based on the stress relationships and the discrete and elements being identified as being in the crack state, the release state and the undamaged state; and
project a crack progression based on the crack propagation growth rate and the crack propagation.

13. The computing device of claim 12, wherein the set of instructions, when executed by the at least one processor, cause the computing device to:
model the crack propagation, the crack propagation growth rate and the release response across a plurality of failure modes; and
identify one or more physical modifications to the component to increase a safety factor associated with the component based on the stress relationships.

14. The computing device of claim 13, wherein the set of instructions, when executed by the at least one processor, cause the computing device to:
model the crack propagation, the crack propagation growth rate and the release response across a plurality of loading modes to bypass one or more testing processes associated with static and fatigue testing, wherein the plurality of loading modes includes one or more of a static load, an impact load or a fatigue load.

15. A method comprising
generating a plurality of discrete and finite elements associated with a component, wherein a number of the plurality of discrete and finite elements corresponds to a size of an estimated process zone;
identifying material input properties of the component;
modelling a release response in the plurality of discrete and finite elements based on the material input properties; and
modelling crack initiation and propagation throughout the plurality of discrete and finite elements based on the release response.

16. The method of claim 15, further comprising:
identifying at least three first finite elements of the plurality of discrete and finite elements as being in a release state based on the release response; and
determine that the at least three first finite elements form a numeric process zone.

17. The method of claim 16, further comprising:
identifying one or more second finite elements of the plurality of discrete and finite elements as being in a crack state based on the release response; and
identifying one or more third finite elements of the plurality of discrete and finite elements as being in an unreleased state based on the release response.

18. The method of claim 15, further comprising:
generating for each respective discrete and finite element of the plurality of discrete and finite elements, a stress relationship between an opening displacement of the respective discrete and finite element and strength of the respective discrete and finite element.

19. The method of claim 18, further comprising:
identifying whether each respective discrete and finite element of the plurality of discrete and finite elements is in a crack state, a release state, or an undamaged state based on the stress relationship of the respective discrete and finite element;
modelling a crack propagation growth rate based on the stress relationships and the discrete and finite elements being identified as being in the crack state, the release state and the undamaged state; and
projecting a crack progression based on the crack propagation growth rate and the crack propagation.

20. The method of claim 19, further comprising:
modelling the crack propagation, the crack propagation growth rate and the release response across a plurality of failure modes to bypass one or more testing processes associated with static and fatigue testing; and
identifying one or more physical modifications to the component to increase a safety factor associated with the component based on the stress relationships.
